(19) United States
(12) Patent Application Publication
(10) Pub. No.: US 2011/0307695 A1
(43) Pub. Date: Dec. 15, 2011

(54) METHODS AND SYSTEMS FOR PROVIDING A SECURE ONLINE FEED IN A MULTI-TENANT DATABASE ENVIRONMENT

(75) Inventor: Steve Slater, Alamo, CA (US)

(73) Assignee: salesforce.com, Inc., San Francisco, CA (US)

(21) Appl. No.: 13/089,726

(22) Filed: Apr. 19, 2011

Related U.S. Application Data
(60) Provisional application No. 61/354,638, filed on Jun. 14, 2010.

(51) Int. Cl. H04L 9/32

(52) U.S. Cl. 713/163

(57) ABSTRACT

Embodiments of the present invention provide systems, apparatus, and methods for securing information shared between users of a database system. A message in a feed on a multi-tenant database can be securely shared when a user marks the message as private. Users of the database can selectively decide on which recipient and/or group of recipients have access rights to view the message. The messages are secured through cryptography, such as by a key shared between two or more users. The user can additionally have a private key that is used to decrypt the secure (e.g., encrypted) messages. This private key can be further protected by the user's password used to log into the database system. The secure message can appear in either encrypted form or be absent from the feed to which the secure message is posted. Secure messages can be transparently encrypted and decrypted by the system. In some embodiments, sharing rules can be pre-defined by the user to determine how messages are secured. Furthermore, the secured messages are stored in encrypted fomi on the multi-tenant database and only accessible by users with whom the messages are shared.

The present application claims benefit under 35 USC 119(e) of U.S. provisional Application No. 61/354,638, filed on Jun. 14, 2010, entitled “METHODS AND SYSTEMS FOR PROVIDING A SECURE ONLINE FEED IN A MULTI-TENANT DATABASE ENVIRONMENT,” the contents of which is incorporated herein by reference in its entirety.

### CROSS REFERENCE TO RELATED APPLICATIONS

This application is related to the commonly owned, co-pending U.S. non-provisional patent application Ser. No. 12/945,410, entitled “SYSTEMS AND METHODS FOR IMPLEMENTING ENTERPRISE LEVEL SOCIAL AND BUSINESS INFORMATION NETWORKING,” by Lee, filed Nov. 12, 2010 (Attorney Docket No. 021735-005910US), which is incorporated by reference herein in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The present invention relates generally to database systems, and more particularly to providing secure messages within a feed in an on-demand enterprise services environment.

Running a company typically requires maintaining data related to the company's business, such as sales numbers, customers, business opportunities, and other information pertinent to sales, revenue, networking. This data is stored on a database that is accessible to various individuals belonging to that company. Often, it is more effective for the company to have a third party maintain a database containing the data, as opposed to the company maintaining the database itself. Accordingly, in some cases, the database can be a multi-tenant database which maintains data for multiple companies.

Providing both social and business networking both within and between these companies offers an invaluable tool in the current technology based infrastructure. Not only can the networking facilitate communication between individuals, but it can also facilitate communications between groups of individuals, both within a single company and between several different companies. However, securing ones privacy during this communication is also desirable as some information may be privileged between two individuals or a specific group of individuals. Additionally, in general, the data of the company may be highly sensitive, and the company may wish to keep the shared data confidential from hackers or even from the third party database operators. For example, a company may desire, and even be required by law, to maintain a legal document confidential between the parties in which it is shared. However, the company may wish to still provide efficient and easy access of information, such as the aforementioned document, to its employees and to other users of the database, which have rights to view the document.

Therefore it is desirable to provide systems and methods that overcome the above and other problems relating to the secure sharing and storage of shared information in a feed maintained on an external server, such as a multi-tenant database.

### BRIEF SUMMARY

Embodiments of the present invention provide systems, apparatus, and methods for securing information shared between users of a database system. In particular, embodiments of the present invention provide a method of securely sharing a message in a feed on a multi-tenant database. Users of the database can decide to secure messages in the feed, dependent on which recipient and/or group of recipients to whom the user selectively gives access rights to view the message. The access rights are given by a key which is commonly shared between the user and the recipients. The messages are secured through cryptography, such as by the key shared between two or more users. The user can additionally have a private key that is used to decrypt the secure (e.g., encrypted) messages. This private key can be further protected by the user's password used to log into the database system. The secure message can appear in either encrypted form or be absent from the feed to which the secure message is posted. When a user having a valid decryption key accesses the feed in which the secure message is posted, the message is transparently decrypted by the system. In some embodiments, sharing rules can be created by the user and/or owner of a feed, which deter mine how and which messages are secured within a feed. The secured message are also stored in encrypted form on the multi-tenant database, ensuring that not even administrators of the database can access and view the messages without a proper key.

In one embodiment and by way of example, a method of securely sharing a message in a feed of an object on a database system is described. The method includes receiving a message from a user of the database system, associating the message with the feed of the object. A plurality of users has access to the feed and the message is selectively shared with one or more intended recipients of the plurality of users. The method further includes encrypting the message with a first key and storing the encrypted message in a table of the database system, retrieving the encrypted message from the table, and decrypting the encrypted message with a second key when one or more of the intended recipients requests the feed. The table is used in providing the feed. Each of the one or more intended recipients has access to the second key. A computer program product comprising a tangible computer readable medium storing a plurality of instructions for controlling a processor to perfoim an operation for securing an element of a feed in a database system described in the aforementioned method is also provided.

In another embodiment and by way of example, a method for securing data in a feed associated with an object on a database system is described. The method includes assigning a first key and a second key to a user, encrypting the first key with a password set by the user, and utilizing the decrypted first key to decrypt data in the feed. The first key is decrypted with the password when the user logs into the database system. The data is shared by at least one of a plurality of users having access to the feed and the data shared by the at least one of a plurality of users is encrypted with the second key.

In a yet another embodiment and by way of example, a method for securely sharing data between a group of users in a feed associated with an object on a database system is described. The method includes receiving data from a user in the group of users, encrypting the data with a first key of the user, utilizing a second key to encrypt the first key, displaying the encrypted data in the feed, and storing the encrypted data on the database system. The second key is formed from a set of unique keys and each user in the group of users being associated with a unique key in the set. The feed is accessible to a plurality of users on the database system.

While the present invention is described with reference to an embodiment in which techniques for performing searches of feeds in an on-demand enterprise services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples of the invention, the invention is not limited to the examples depicted in the figures.

FIG. 1 illustrates a block diagram of an example of an environment wherein an on-demand database service might be used.

FIG. 2 illustrates a block diagram of an embodiment of elements of FIG. 1 and various possible interconnections between these elements.

FIG. 3 illustrates an exemplary table of tenants and related entities stored in an on-demand database system.

FIG. 4 is a flowchart of a method 400 implemented on a third party database for securing feed elements in a database system.

FIG. 5 is a flowchart of a method 500 for entering a secure message to a feed and for providing the message to a group of users from the secure message stored on a third party database system according to an embodiment.

FIG. 6A illustrates an exemplary screenshot of a feed for an Opportunity object as viewed by user C according to an embodiment.

FIG. 6B illustrates an exemplary pop-up window that is displayed to user C when a message in the feed is selected to be private according to an embodiment.

FIG. 6C-E illustrate exemplary tables in which feed elements are stored for the feed of FIG. 6A on a multi-tenant database according to an embodiment.

FIG. 6F is an exemplary screenshot of the feed of FIG. 6A including a private message as viewed by user B according to an embodiment.

FIGS. 6G-6H illustrate exemplary screenshots of FIG. 6A including a private message as viewed by user E according to some embodiments.

### DETAILED DESCRIPTION

Embodiments of the present invention provide a method of securely sharing a message (e.g., data, information, post) in a feed between both tenant users and tenants of a multi-tenant database. Users of the database can selectively secure a message posted in the feed by marking the message as private when submitting (i.e., “posting”) the message to a feed, or by pre-selecting sharing rules for object feeds in which he/she is an administrator. In some embodiments, a user has a private key, which is known only to that user and used to decrypt secure (e.g., encrypted) messages that have been shared with that user by other users. The shared feed information (e.g., a message) is encrypted either using a user's personally assigned public key or a shared public key, such as a symmetric key, which is formed by a number of keys belonging to two or more users having access rights to view the message posted into the feed. For example, a public key could be formed between the keys of a user into whose profile the message is being posted and a user who is posting the message, or, a number of users belonging to a group. Encrypted data, such as that within a private message posted to a feed, is viewable by those having access to the key utilized to encrypt the message, while the same message may be invisible or displayed in encrypted form for those not having access to the public key. The data (e.g., text) of the message posted into the feed is transparently decrypted and encrypted by the system.

Various other embodiments allow for a user to create groups within a plurality of users that subscribe to a specific feed. The user can then selectively share messages with only users within a specified group, users in a number of specified groups, individual users, or with all of the plurality of the users subscribing to that feed. The sharing rules associated with a feed can also determine which messages are viewable by users on the database system.

Embodiments of the present invention also provide a method in which messages in the feed are securely stored on the multi-tenant database. If the message is marked ‘private’ by a user, the data (e.g., text) in the message is encrypted by the public key of the users with whom the message is shared and then stored in a table associated with the feed of an object in which the message is being posted. A field can be present in the feed table, which indicates the subscribers with whom that message is being shared and/or the key used to encrypt the message. In one example, only a user with whom the message was shared can decrypt the message with his/her private key. The user's private key is securely protected by his/her individual password, which utilized to gain access to the database system and known only to each respective user. The user's private key is encrypted when the user is not actively using the database system (e.g., when the user logs out).

### I. General Overview

Systems and methods are provided for systems and methods for implementing security in a feed for enterprise level social and business information networking on a multi-tenant database system.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Enterprise level social and business information networking can allow for the multi-tenant database system users to subscribe to or “follow” other users in the system along with other “feeds” related to specific database entries. Following a user provides access to real-time updates about other users and the data entries (e.g., messages, updates, stories, etc.) added to followed feeds within the multi-tenant database system. A user can have multiple subscribers, and multiple subscribers can also belong to groups. Each group may be related to an object on the database, such as an Opportunity page of a tenant, and each user can be an object on the database. Records of the data added to each feed associated with an object can be stored as tables on the database. The records can include fields, which determine how the data is to be stored and displayed in a feed as well as maintain a list of the subscribers to that feed, along with any additional information and/or rules defined for that feed.

An example of the aforementioned type of enterprise level networking is referred to herein as Chatter®. Chatter® is a social networking service provided by salesforce.com, inc., that, in an embodiment, facilitates networking between users of tenants in a multi-tenant database. In some situations, the Chatter® of shared information (e.g., a feed) between users is privileged information, which is only to be viewed by certain users within the multi-tenant database system. Accordingly, in order to provide added security to the feed across the system, encryption methods can be implemented to selectively secure not only the transfer of information from one user to another (i.e., the posting of the message to the feed), but also to secure the stored entry of that information within the multi-tenant database system.

For example, though user A subscribes to (i.e., “follows”) user B, user A may not want all other users whom subscribe to user B to view a message posted to user B's feed. Accordingly, the message is encrypted so that only user A and user B can decrypt the message for viewing. For all intents and purposes, the viewing of the message is transparent to user A and user B as a common key is shared between them. The key can be controlled and distributed by the database system, though only accessible to the users with which the key is shared. Likewise, when the data in a feed (e.g., a message) is stored within the database system, the data can be encrypted with the shared key.

An overview of a multi-tenant database system in which the secure Chatter® can be implemented will be described in the following sections, followed by the mechanisms and methods for implementing secure Chatter® (e.g., feed) communication between users on that database system. The following description of securing aspects of Chatter® and the database system is made with reference to example embodiments.

### II. System Overview

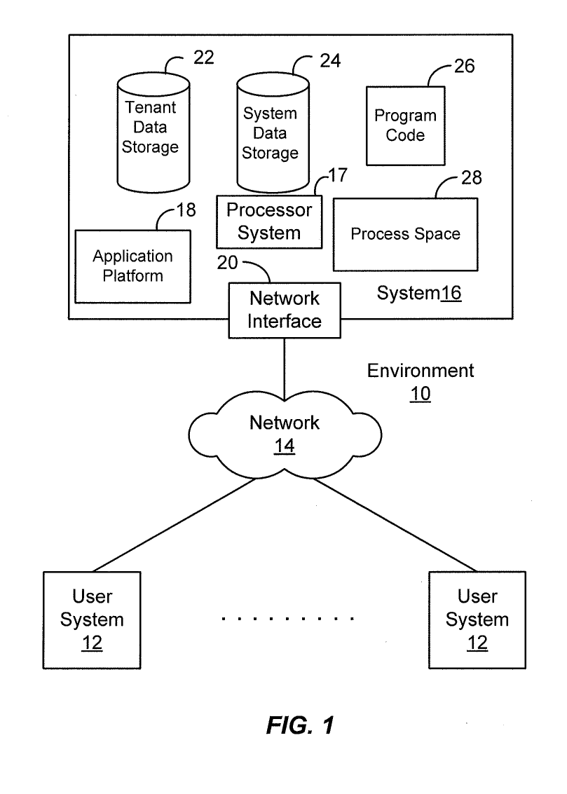

FIG.1 illustrates a block diagram of an environment 10 wherein an on-demand database service might be used. Environment 10 may include user systems 12, network 14, system 16, processor system 17, application platform 18, network interface 20, tenant data storage 22, system data storage 24, program code 26, and process space 28. In other embodiments, environment 10 may not have all of the components listed and/or may have other elements instead of, or in addition to, those listed above.

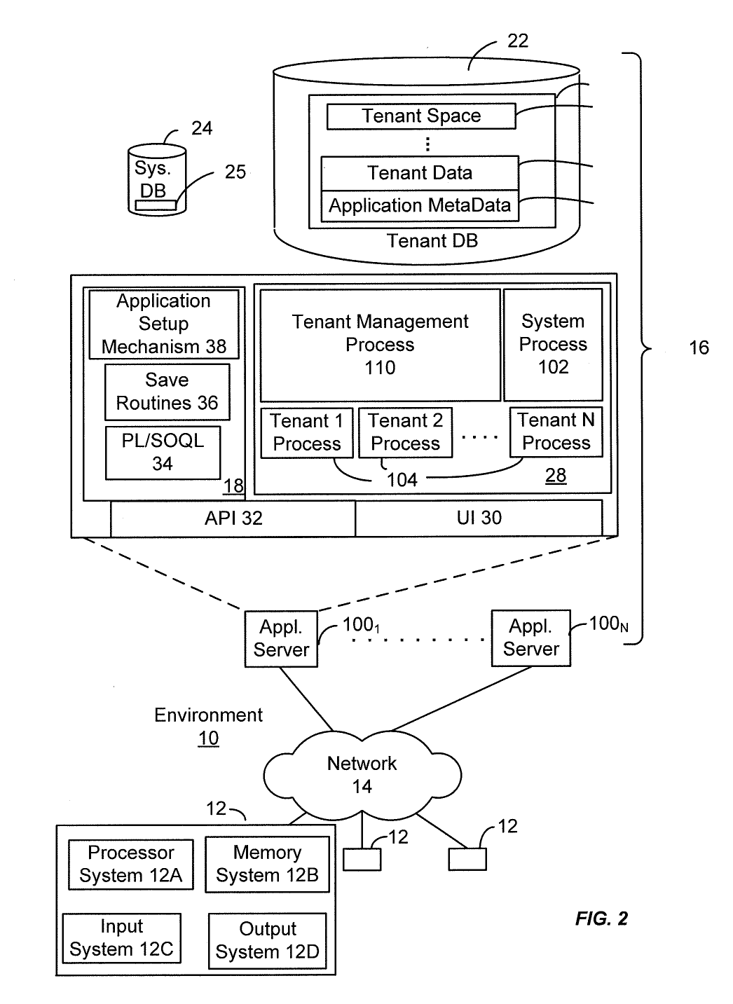

Environment 10 is an environment in which an on-demand database service exists. User system 12 may be any machine or system that is used by a user to access a database user system. For example, any of user systems 12 can be a handheld computing device, a mobile phone, a laptop computer, a work station, and/or a network of computing devices. As illustrated in FIG. 1 (and in more detail in FIG. 2) user systems 12 might interact via a network 14 with an on-demand database service, which is system 16.

An on-demand database service, such as system 16, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 16” and “system 16” will be used interchangeably herein. A database image may include one or more database objects. A relational database management system (RDMS) or the equivalent may execute storage and retrieval of information against the database object(s). Application platform 18 may be a framework that allows the applications of system 16 to run, such as the hardware and/or software, e.g., the operating system. In an embodiment, on-demand database service 16 may include an application platform 18 that enables creation, managing and executing one or more applications developed by the provider of the on-demand database service, users accessing the on-demand database service via user systems 12, or third party application developers accessing the on-demand database service via user systems 12.

The users of user systems 12 may differ in their respective capacities and the capacity of a particular user system 12 might be entirely determined by permissions (permission levels) for the current user. For example, where a salesperson is using a particular user system 12 to interact with system 16, the user system 12 has the capacities allotted to that salesperson. However, while an administrator is using that user system to interact with system 16, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 14 is any network or combination of networks of devices that communicate with one another. For example, network 14 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global inter-network of networks often referred to as the “Internet” with a capital “I,” that network will be used in many of the examples herein. However, it should be understood that the networks that the present invention might use are not so limited, although TCP/IP is a frequently implemented protocol.

User systems 12 might communicate with system 16 using TCP/IP and, at a higher network level, use other common Internet protocols to communicate, such as HTTP, FTP, AFS, WAP, etc. In an example where HTTP is used, user system 12 might include an HTTP client commonly referred to as a “browser” for sending and receiving HTTP messages to and from an HTTP server at system 16. Such an HTTP server might be implemented as the sole network interface between system 16 and network 14, but other techniques might be used as well or instead. In some implementations, the interface between system 16 and network 14 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 16, shown in FIG. 1, implements a web-based customer relationship management (CRM) system. For example, in one embodiment, system 16 includes application servers configured to implement and execute CRM software applications as well as provide related data, code, forms, webpages and other information to and from user systems 12 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared, such as will be described in the case of feeds (i.e., a feature of “Chatter®”). In certain embodiments, system 16 implements applications other than, or in addition to, a CRM application. For example, system 16 may provide tenant access to multiple hosted (standard and custom) applications, including a CRM application. User (or third party developer) applications, which may or may not include CRM, may be supported by the application platform 18, which manages creation, storage of the applications into one or more database objects and executing of the applications in a virtual machine in the process space of the system 16.

One arrangement for elements of system 16 is shown in FIG. 1, including a network interface 20, application platform 18, tenant data storage 22 for tenant data 23, system data storage 24 for system data 25 accessible to system 16 and possibly multiple tenants, program code 26 for implementing various functions of system 16, and a process space 28 for executing MTS system processes and tenant-specific processes, such as running applications as part of an application hosting service. Additional processes that may execute on system 16 include database indexing processes.

Several elements in the system shown in FIG. 1 include conventional, well-known elements that are explained only briefly here. For example, each user system 12 could include a desktop personal computer, workstation, laptop, PDA, cell phone, or any wireless access protocol (WAP) enabled device or any other computing device capable of interfacing directly or indirectly to the Internet or other network connection. User system 12 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 12 to access, process and view information, pages and applications available to it from system 16 over network 14. Each user system 12 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 16 or other systems or servers. For example, the user interface device can be used to access data and applications hosted by system 16, and to perform searches on stored data, and otherwise allow a user to interact with various GUI pages that may be presented to a user. As discussed above, embodiments are suitable for use with the Internet, which refers to a specific global inter-network of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium® processor or the like. Similarly, system 16 (and additional instances of an MTS, where more than one is present) and all of their components might be operator configurable using application(s) including computer code to run using a central processing unit such as processor system 17, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 16 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments of the present invention can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 16 is configured to provide webpages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates environment 10. However, in FIG. 2 elements of system 16 and various interconnections in an embodiment are further illustrated. FIG. 2 shows that user system 12 may include processor system 12A, memory system 12B, input system 12C, and output system 12D. FIG. 2 shows network 14 and system 16. FIG. 2 also shows that system 16 may include tenant data storage 22, tenant data 23, system data storage 24, system data 25, User Interface (UI) 30, Application Program Interface (API) 32, PL/SOQL 34, save routines 36, application setup mechanism 38, applications servers 100₁-100_{N}, system process space 102, tenant process spaces 104, tenant management process space 110, tenant storage area 112, user storage 114, and application metadata 116. In other embodiments, environment 10 may not have the same elements as those listed above and/or may have other elements instead of, or in addition to, those listed above.

User system 12, network 14, system 16, tenant data storage 22, and system data storage 24 were discussed above in FIG. 1. Regarding user system 12, processor system 12A may be any combination of one or more processors. Memory system 12B may be any combination of one or more memory devices, short term, and/or long term memory. Input system 12C may be any combination of input devices, such as one or more keyboards, mice, trackballs, scanners, cameras, and/or interfaces to networks. Output system 12D may be any combination of output devices, such as one or more monitors, printers, and/or interfaces to networks. As shown by FIG. 2, system 16 may include a network interface 20 (of FIG. 1) implemented as a set of HTTP application servers 100, an application platform 18, tenant data storage 22, and system data storage 24. Also shown is system process space 102, including individual tenant process spaces 104 and a tenant management process space 110. Each application server 100 may be configured to tenant data storage 22 and the tenant data 23 therein, and system data storage 24 and the system data 25 therein to serve requests of user systems 12. The tenant data 23 might be divided into individual tenant storage areas 112, which can be either a physical arrangement and/or a logical arrangement of data. Within each tenant storage area 112, user storage 114 and application metadata 116 might be similarly allocated for each user. For example, a copy of a user's most recently used (MRU) items might be stored to user storage 114. Similarly, a copy of MRU items for an entire organization that is a tenant might be stored to tenant storage area 112. A UI 30 provides a user interface and an API 32 provides an application programmer interface to system 16 resident processes to users and/or developers at user systems 12. The tenant data and the system data may be stored in various databases, such as one or more Oracle™ databases.

Application platform 18 includes an application setup mechanism 38 that supports application developers' creation and management of applications, which may be saved as metadata into tenant data storage 22 by save routines 36 for execution by subscribers as one or more tenant process spaces 104 managed by tenant management process 110 for example. Invocations to such applications may be coded using PL/SOQL 34 that provides a programming language style interface extension to API 32. A detailed description of some PL/SOQL language embodiments is discussed in commonly owned co-pending U.S. Pat. No. 7,730,478 entitled, “METHOD AND SYSTEM FOR ALLOWING ACCESS TO DEVELOPED APPLICATIONS VIA A MULTI-TENANT ON-DEMAND DATABASE SERVICE,” by Craig Weissman, filed Sep. 21, 2007, which is incorporated in its entirety herein for all purposes. Invocations to applications may be detected by one or more system processes, which manage retrieving application metadata 116 for the subscriber making the invocation and executing the metadata as an application in a virtual machine.

Each application server 100 may be communicably coupled to database systems, e.g., having access to system data 25 and tenant data 23, via a different network connection. For example, one application server 100₁ might be coupled via the network 14 (e.g., the Internet), another application server 100_{N-1} might be coupled via a direct network link, and another application server 100_{N} might be coupled by yet a different network connection. Transfer Control Protocol and Internet Protocol (TCP/IP) are typical protocols for communicating between application servers 100 and the database system. However, it will be apparent to one skilled in the art that other transport protocols may be used to optimize the system depending on the network interconnect used.

In certain embodiments, each application server 100 is configured to handle requests for any user associated with any organization that is a tenant. Because it is desirable to be able to add and remove application servers from the server pool at any time for any reason, there is preferably no server affinity for a user and/or organization to a specific application server 100. In one embodiment, therefore, an interface system implementing a load balancing function (e.g., an F5 Big-IP load balancer) is communicably coupled between the application servers 100 and the user systems 12 to distribute requests to the application servers 100. In one embodiment, the load balancer uses a least connections algorithm to route user requests to the application servers 100. Other examples of load balancing algorithms, such as round robin and observed response time, also can be used. For example, in certain embodiments, three consecutive requests from the same user could hit three different application servers 100, and three requests from different users could hit the same application server 100. In this manner, system 16 is multi-tenant, wherein system 16 handles storage of, and access to, different objects, data and applications across disparate users and organizations.

As an example of storage, one tenant might be a company that employs a sales force where each salesperson uses system 16 to manage their sales process. Thus, a user might maintain contact data, leads data, customer follow-up data, performance data, goals and progress data, etc., all applicable to that user's personal sales process (e.g., in tenant data storage 22). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 16 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant-specific data, system 16 might also maintain system level data usable by multiple tenants or other data. Such system level data might include industry reports, news, postings, and the like that are sharable among tenants.

In certain embodiments, user systems 12 (which may be client systems) communicate with application servers 100 to request and update system-level and tenant-level data from system 16 that may require sending one or more queries to tenant data storage 22 and/or system data storage 24. System 16 (e.g., an application server 100 in system 16) automatically generates one or more SQL statements (e.g., one or more SQL queries) that are designed to access the desired information. System data storage 24 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to the present invention. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

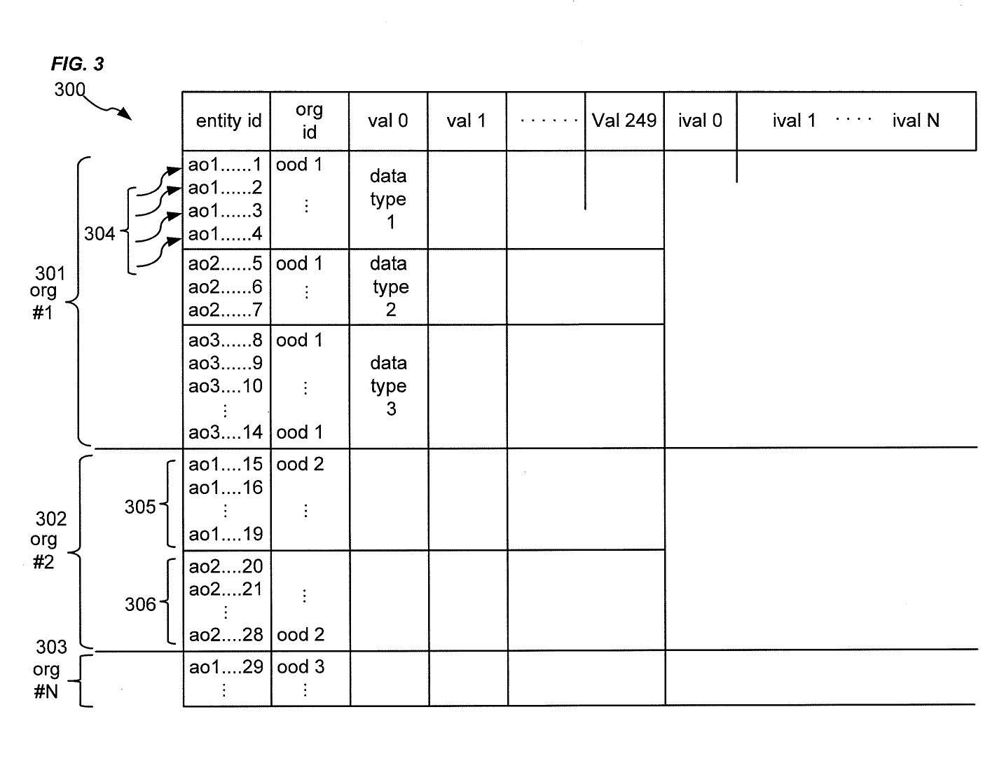

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “CUSTOM ENTITIES AND FIELDS IN A MULTI-TENANT DATABASE SYSTEM”, and which is hereby incorporated herein by reference, teaches systems and methods for creating custom objects as well as customizing standard objects in a multi-tenant database system. In certain embodiments illustrated in FIG. 3, for example, all custom entity data rows 304, are stored in a single multi-tenant physical table 300, which may contain multiple logical tables 305, 306, per organization. It is transparent to customers 301, 302, 303, that their multiple “tables” (e.g., 305, 306) are in fact stored in one large table or that their data may be stored in the same table as the data of other customers.

Theses customers, or tenants, may also be able to share these entities or objects or selective information relating to those entities with other customers subscribing to the database as well as between users having access to that customer's entities. The aforementioned shared information, which also can be referred to as Chatter® by salesforce.com, inc., facilitates social and business networking between users of the tenants in the multi-tenant database. If a customer provides public access rights to view a particular entity (i.e., object), any number of users can subscribe to that entity. Accordingly, if any form of Chatter® (e.g., data in a feed) is added to a feed of that entity, modifications and/or additions are made to the information stored in the record (e.g., a table) for that entity, and a story, message, post or other data shared in the feed is made viewable to the subscriber(s). However, if a user views the entity without being a subscriber, the user may or may not be able to the view any of the data, or may be able to view only one or more elements provided in the feed associated with that entity. These viewing rights are dependent on the privacy settings can be imposed not only by the user that provided the data (e.g., message, comment) to the feed, but also the settings associated with the entity of the feed.

The following detailed description will explain the aforementioned privacy settings which control the encryption and decryption, and consequent viewing capabilities of specified data (e.g., messages) within a feed. The detailed description will first provide an overview of Chatter® and the definitions of the terms for elements relating to networking which implements Chatter®. The following sections then describe methods of securing data elements in Chatter® (e.g., a feed elements) associated with an object in accordance with aspects and embodiments. The sharing rules to provide secure data shared in a feed between individual users and groups of users will also be defined. The securing of the feed data may include various encryption, decryption, storage, and retrieval techniques. Further, exemplary encryption techniques that can be utilized to implement the aforementioned methods are then described.

### III. Chatter®

Chatter® is a term used to describe social and business networking between users of tenants in a multi-tenant database. This networking can be implemented by tracking updates made on the database, such as modifications of data in a record (e.g., stories), or data posted to a feed (e.g., comments, posts, messages) by a user. Chatter® is further described in commonly owned U.S. patent application Ser. No. 12/945,410, filed Nov. 12, 2010, entitled “Enterprise Level Business Information Networking for Changes in a Database,” which is incorporated by reference.

Feeds are a stream of news stories about what other users are doing in the database system. In one aspect, they are a way to stay up-to-date as well as an opportunity to reach out to your co-workers/partners and engage them around common goals. Feeds can include stories, messages, comments and posts, which are added by other users whom subscribe to that entity, or object on the database system.

Stories describe events that happen to a record (including a user record). In one embodiment, the stories are conveyed in complete sentences, and thus can be easily understood as they are in “plain English.” In various embodiments, stories can be generic containers with formatting restrictions, can be published to multiple feeds, can be deleted by the author (which deletes story from all feeds), can include multiple change events in one story (john changed the account status and amount . . .), and respects sharing and field-level security (FLS).

Feeds include Stories and can show up across an application associated with the database. Feeds can be scoped to the context of the page on which they are being displayed. For example, how a story is presented can vary depending on which page it is being displayed (e.g. in news feeds, discussed below). In one embodiment, a feed can contain a finite number of stories (e.g. 50).

Events are activities in the system that trigger a story. For example, an event can be whenever data is saved to a record or to one of its related records, or the creation/deletion of a record. The events that trigger a story for a record can be restricted to changes for only certain fields of the record, which can differ depending on which user is receiving the feed. Likewise, in an embodiment, a record can include a field indicating that specific events in the Events History Table are private, which automatically encrypts stories triggered by those events. Encryption of messages is further described below and this type of selective encryption of private data marked private can be similarly applied to records of objects (i.e., entities).

Entity Feeds are feeds on an entity record (like Account, Opportunity, Case, Contact). For example, an entity feed can tell a user about the actions that people have taken on that particular record or on one its related records. The entity feed can include who made the action, which field was changed, and the old and new values. In one embodiment, a user can access an entity feed by viewing the record, and the feed can be displayed on a home page (detail page) of the entity. Stories of an entity feed can also be posted (published) via a news feed. In one embodiment, Entity Feeds can exist on all supported object detail records as a related list.

Profile Feeds exists for user profiles and can tell a first user about all the actions that a person (whose profile feed is being viewed) has taken across all the objects that are visible to the first user. A profile feed can be provided on a user's profile page. In one embodiment, a profile feed can be considered a special type of entity feed on the user record. For example, if a user record stores activities of the user, the profile feed can provide stories about these updates to the user record. In one embodiment, Profile Feeds contain stories about the last 50 actions (or some other amount) this user took that created an event. A Profile Feed can also include shared information from one user to the person whose profile feed is being viewed in the foam of a post, comment or message, all which are explained in further detail in the following paragraphs. In another embodiment, a Profile Feed can include the last 50 data entries to the feed, such as stories, comments, messages and posts.

A News Feed is an aggregated feed of all the entity feeds to which a user subscribes. The news feed, which may also be referred to generally as a feed, can be provided on the home page of the subscribing user. Thus, a news feed can be created by and exist for a particular user. For example, a user can subscribe to receive entity feeds of certain records that are of interest to the user, and to receive profile feeds of people that are of interest (e.g. people on a same team, that work for the user, are a boss of the user, etc.). A news feed can tell a user about all the actions across all the records (and people) you've explicitly (or implicitly) subscribed to via the

Subscriptions Center (described below). In one embodiment, only 1 instance of each story is shown on a user's news feed, even if the story is published in multiple entities to which the users is subscribed. In one aspect, there may be delays in publishing news articles. For example, the delay may be due to queued up messages for asynchronous entity history persistence. Different feeds may have different delays (e.g. delay for new feeds, but none of profile and entity feeds). In another embodiment, certain stories regarding a subscribed profile feed or an entity feed are not shown because the user is not allowed, e.g. due to sharing rules (which restrict which users can see which data).

In one embodiment, a group feed can be setup, where a group of users receive the same data posted to the feed. In various embodiments, the group can be created based on certain criteria that are common to the users, can be created by inviting users, or can be created receiving requests to join from a user.

Also, in some embodiments, the record that has been updated, which includes creation of the record, can be provided in the feed (e.g. as a flash rendition of the document) to show which users are part of the group. This can be accomplished by altering the settings of the group feed. For instance, when a field changes in the record, or a new field is added, a column (or row), which includes the users of group in the record of the group feed, is copied into the feed.

In one embodiment, sharing rules and FLS are applied when the feed is being displayed. In another embodiment, profile feeds can be updated immediately after action is taken, such as when a message or comment is posted to the feed.

In some embodiments, a Subscription Center acts as a centralized place in the application associated with the database (e.g. application platform 18) to manage which records a user subscribes to, and which field updates the user wants to see on those stories. The Subscription Center can use a subscription table to keep track of the subscriptions of various users. In one embodiment, the subscription center shows a list of all the items to which a user is subscribed. A user can unsubscribe to subscribed objects from the subscription center. In an embodiment, when stories are created dynamically, access rule checks are not done upon subscription or unsubscription. In another embodiment, access rule checks are done upon subscription or unsubscription. For instance, the privacy rules of an object are imposed upon subscription to an object and keys are automatically generated and stored between the object and the subscriber upon subscription. The sharing of keys for access to shared information in a feed is detailed further in the section labeled “Securing Feed Data.”

In one embodiment, a user may be required to have read access on an entity to create a subscription to it. For example, a user cannot subscribe to a private object to which public access is not available. This can minimize (but not eliminate) the case where a user is subscribed to entities they cannot access which slows down news feed queries.

In one embodiment, there is an Auto Subscription feature. This automatic subscription can ensure that a user is receiving certain feeds. Auto subscription can happen upon: 1.) New entity creation: the owner (not necessarily the user who created the entity) is subscribed; 2.) Ownership change: the new owner should become auto subscribed; and 3.) Lead convert: the user doing lead convert should be auto subscribed to the new account, opportunity and contact. Auto subscription can be controlled by per user preference. The user-preference can be a negative preference so that the default is to auto-subscribe.

Comments can be added to (hang off) any story and a user can reply to other comments on the same story. In one embodiment, story comments don't trigger other stories. In another embodiment, comments stay with the story, so if a comment is made in the News Feed, it propagates to the appropriate Entity Feed as well. If a story is deleted, its corresponding comments are deleted as well. Comments can also be filtered. For example, a tab can exist to see all comments made by the user and its corresponding stories. In yet another embodiment, new comments don't update the story timestamp. Also, the story can be continued to show if it has had a comment within the last week.

In some embodiments, most stories can be commented on. In other embodiments, Ideas Stories, Collaboration Stories, and Case Stories are not commentable. In one embodiment, if a user in whose profile feed the story is located or the user who causes the generation of the story to occur marks the story as “private”, the story cannot be commented on. In a further embodiment, if the story is marked private prior to generation, the story may not appear in any feed. In further embodiments, only a user who has access to a story, i.e., caused the generation of the story, can comment on the story.

Wall Posts are comments on a profile page or an entity page, as opposed to a comment on a specific story. Wall posts are another form of a story, which is not triggered by a change to the record in the system, but an addition to the record on a profile page or entity page made by a user having access to those pages. In one embodiment, the Wall posts can last forever. In some embodiments, wall posts can be appended to other wall posts, similar to comments on stories, as described above. As will be described in further detail in the following sections, these wall posts, which may also be referred to as messages, feed data or, generally, as posts, can be selectively visible to users on the database system. The user entering the message into a feed can pre-select the sharing rules for messages originating from that user, such as in other's profile pages, entity pages or to groups. Alternatively, the user can select which other users or groups of users will have access to view the message once it is entered. In some embodiments, the user whose profile feed into which the message is posted can also impose sharing rules on the message.

Status Posts are short, SMS-sized messages posted by users that can answer a specific question, which can be posted as a comment or wall post. In one embodiment, status posts also can last forever. In an embodiment, users can rate the different status posts so that a best answer can be identified.

In some embodiments, stories, comments, and posts can be provided on feeds associated with users of different tenants or within the originating tenant, as well as objects in different tenants or within the originating tenant. Sharing rules can ensure that users do not see data within a feed that they are not permitted to see as selected by the user adding that data to a feed or administrator of an object which accepts feed data from a plurality of users on the multi-tenant database system. For instance, if a tenant allows a particular object (e.g., user profile, opportunity, etc.) to be “public”, other tenants may readily view the data posted in the feed associated with that object. Alternatively, only feed data associated with specific fields of that object may be viewable, or only data (e.g., posts, messages, comments) left “public” by the subscribers to the object feed may be viewable by all the subscribers or users having viewing access to that feed. In some embodiments, only the subscribers to that object feed may view the data in the feed. These sharing rules, along with how the shared data is protected both between users and tenants, are further explained in the following sections.

A Feed Generator can generate the top stories (e.g. 50) and story comments that show up on Entities, Profiles and news Feeds. The feed generator can de-dupe events (i.e. prevent duplicates) that are generated from numerous objects. For example, since a story can be published to multiple feeds (e.g. John Choe changed the Starbucks Account Status) and a person can be subscribed to both the Starbucks account and John Choe, embodiments can filter out duplicates before displaying the items in a news feed. Thus, the Feed Generator can collapse events with multiple records for a single transaction into a single story and ensures the right number of stories for the particular feed.

In one embodiment, feeds are generated by the feed generator by querying the appropriate subset of: The Feeds Entity History, Status posts, Wall posts and associated story comments. What gets recorded in the Entity history table, as well as what is displayed, is controlled by the Feed Settings page in setup, which is configurable by an administrator and is the same for the entire organization. The Feed Generator can also check to make sure that no one sees data that they don't have access to see (e.g. according to sharing rules queried in the

Feed Entity table). In one embodiment, in the news feed, the Feed Generator looks at a person's subscription center to decide which feeds to query and returns a de-duped list of stories for the user. This type of security measure is described further in the following Secure Feeds section.

There can be various feed settings for the generation of different feeds. For profile feeds and entity feeds, stories can be written for all standard and custom fields on the supported objects. Feed settings can limit how many and which fields are be tracked per object. In one embodiment, there is a separate limit for number (e.g. 20) of trackable fields for entity history changes shown in the feed. A separate UI can exist to capture those changes. In another embodiment, default values may be picked for the field preferences table and eventually expose it in a “Subscriptions Center.”

In some embodiments, feed queries only return changes in records (stories) for entities for which the user has access. In one aspect, an individual field change may not be visible if the user does not have FLS access to the field of a particular object.

Regarding viewing privileges of feed, in one embodiment, a user can always see all of his own subscriptions (even if he's lost read access to the parent record). For access to other user's and entity's subscriptions, a user can be required to need read-access on the parent-id to see the subscription. Having visible access to the subscriptions can be determined in the initial set-up of the feed associated with a user and/or entity.

Regarding create and delete privileges, in one embodiment, users with having the ability to modify all data, e.g., administrator rights, can create and delete any subscriptions to an object. For example, if a user is an administrator of an entity, or has all access rights to that entity, the user may be able to delete one or more subscribers in the plurality of users subscribing to that entity. However, other users in the plurality of users subscribing to that entity may only be able to discontinue their own subscription to that entity. In another embodiment, a user can create and delete subscriptions only for his/herself.

Once a subscription to an entity or other user is discontinued (e.g., deleted), sharing rules for viewable access to data within the entity's feed are also discontinued, or imposed, dependent on how the rules are defined for that particular feed. However, any sharing rules defined by the user whose subscription to the feed has been deleted, are automatically discontinued as well. The sharing rules applying to feed elements are further described below in section V.

Supported Events include actions for standard fields, custom fields, and standard related lists. Regarding standard fields, for the entity feed and the profile feed, a standard field update can trigger a story to be published to that feed. In one embodiment, which standard field can create a story visible in the entity feed can be set by an administrator of the entity. In another embodiment, a user can set which standard fields create a story for that user's feed if they are subscribing to that entity and associated fields, and if the administrator has granted public access rights to those fields. Custom fields can be treated the same or differently than standard fields. User's profile feeds can be treated as custom objects having custom fields defined by the user, or defined by the administrator of the tenant so that specific events triggering stories within a feed can be made visible to only a limited amount of users.

If a user wants to see a feed of the related list item, then the user can subscribe to it. For example, a user may find a specific opportunity related to a specific account to be of interest. Thus, if a user cares about that object, they can always browse to that object's feed, or subscribe to that object in their news feed. In some embodiments, depending on the sharing rules imposed by the owner of an object, the feed of the related list item may or may not be viewable by the user subscribing to that item and/or the feed of the parent object may not be viewable to the user. In one embodiment, all related Objects are tracked separately from the entity history table and each object can include a field identifying whether or not the feed of that object is viewable to a user.

The following section provides further detail on how data, such as messages, within a feed is secured.

### IV. Securing Feed Data

A common approach to securing a database providing this type of social networking is to control access to view the information shared between two individuals, dependent on the group to which those individuals are assigned. For instance, a user A can have a group of users that subscribe to, or follow him/her. The users in that group have access to view the information shared between any one of themselves and user A in a feed, which can be made viewable in user A's profile.

An application can assign the groups of users, and the application can control the aforementioned security for viewing access, based on group membership. A problem with this approach is that company administrators (i.e. administrators of a tenant) and developers and others with special View All Data access have access to ALL data including sensitive (e.g., privileged) information which can be shared between the users in a group. Also, the service provider's administrators (e.g. an administrator of the database) can have access to all data (e.g., shared information in a feed) including sensitive feed data.

Accordingly, the privileged information is not secured to those with an all access capability. Additionally, all of the information shared between the group of users subscribing to user A is accessible to that group of users, i.e. there is no way to keep the shared information in the feed solely between one user in the group and user A.

Another issue arising from this type of networking on a third party database is that the shared information on a feed may also not be stored on the database in a secure manner, as the database administrators can have control over the encryption during the networking process. Using present database systems, it is difficult to monitor the activity of the users of the database, particularly in a secure manner and/or efficient manner.

As mentioned in the previous section, feeds can be composed of feed elements, such as stories, comments, posts, and messages. A feed is utilized for business networking, such as one tenant in the multi-tenant database providing information between users in that tenant and/or between users in two or more tenants. Each user, whether associated with the tenant or not, may have access to view particular records (object and/or fields) of that tenant and to subscribe to them. Each record may include both public and private information associated with it, in which subscribers of different levels of permissions may have visibility. The administrators and/or owner of each record can detennine a predefined set of sharing rules for that record. These rules may be defined for each parent object and correspond to each field of that object. In other embodiments, the sharing rules can be generally defined for each object and associated field of that object, providing the sharing rules for each related record in that object.

Each user which subscribes to a record (i.e., of an object or field of an object) may also define sharing rules in addition to the predefined set of sharing rules for that record. As a result, if a user posts sensitive (e.g., privileged) information into a feed associated with an object (e.g., record, entity or table), that information can be secured so that only a selected user or group of users have viewable access to the information.

When the data (e.g., message, comment, post, story) is stored in the Entity_Feed_History table associated with that object, the data (e.g., a message) can be encrypted in a key only shared by the user providing the message and the intended recipients. Administrators of the database, tenant and/or object, cannot view the message unless the message is explicitly shared with them and a proper decryption key is also shared with them. Accordingly, all private feed messages at rest are securely stored in encrypted form and are less susceptible to hackers and or viewing by anyone other than an intended recipient.

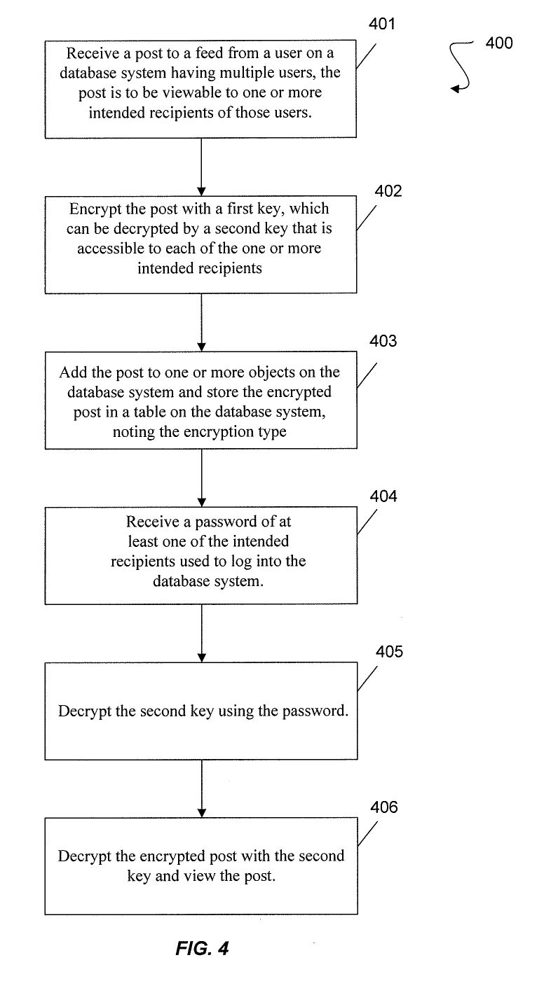

Referring now to FIG. 4, a flowchart is provided illustrating a server-side method 400 of how data, such as a message being entered into an object feed, is encrypted, decrypted and securely stored on a multi-tenant database system. In step 401, the method 400 first provides how a message is entered into the database system from a user. Step 402 describes how the message is encrypted in the system. In step 403, the encrypted message is displayed within an object feed and stored as a record in the database. Step 404 describes how the message is called by another user on the database system when that user is viewing the object feed. Step 405 discusses how the message is decrypted by the system. Finally, step 406 provides how the message is made viewable to a user by the system.

In step 401, a message is entered into feed by a user having access to that feed. The user can be viewing the feed of a particular object (e.g., profile of another user) and enter the message into a text box. In an alternative embodiment, the user can be replying to a feed element (e.g., wall post or comment) in another feed, which is associated with the aforementioned object feed. In some embodiments, the message would then post to both feeds. The system the determines if the message is to be encrypted by either receiving a manual selection by the user when the message is being entered, or by referencing predetetinined sharing rules for a particular feed. For instance, the sharing rules of the feed could specify that any message posted by any subscriber of the feed is to be encrypted, whereas any message by a non-subscriber is to remain public. In the aforementioned embodiment, the feed is public in order for any user to be able to access and post to the feed. In another embodiment, any user subscribing to the feed can see the message posted to the feed.

Alternatively, in an embodiment, the user entering the message can specify one or more intended recipients (e.g., a specific user or group of users subscribing to the feed) which are to be given access rights to view the message. In such a case, other subscribers to the feed may only be able to view selected information that is public to the feed, whereas the intended recipients transparently see the shared data (e.g., posted message). Accordingly, each subscriber of a feed potentially can have a different view of the elements posted in a feed, dependent on what information is shared with them in that feed.

In step 402, if the message is to be encrypted, i.e., the message is marked private, the system uses a first key to encrypt the message. The first key may be a symmetric key or public key, which is formed by one or more private keys belonging to the recipients with whom the message is to be shared.

There are two cryptographic keys which are used on the system. One key is a private key, known only to each individual user, and one is a public key that can be shared between users. The system assigns public keys dependent on the private keys of the users sharing the public key. The public key can be used to encrypt the message, or other element (e.g., comments, stories) on the feed. However, when a user decrypts the message being shared, his/her private key is utilized. Accordingly, when the system receives a message to be posted securely (e.g., encrypted) into a feed, the intended recipients of the message need to be specified to the system in order for the correct public key to be appended to the message and/or generated and provided to the recipients. Private, public and symmetric keys are described in further detail in the following section VI labeled “Encryption.”

In step 403, the encrypted message is then displayed, or posted into the feed. Though the message is stored similarly in the table associated with the feed of an object, the actual encrypted message can either be visually transparent to the users not having access rights to view it in the feed, or can be displayed in an encrypted form known in the art. The display method can be deteiinined by the owner of the object, the administrator of the database, or by the administrator of the tenant. An additional column within the table associated with the feed can include the display type. In the first case scenario, selective information relating to the message can be posted into the feed without the message (i.e., blank message text), such as the user's name who posted the secure message in the feed and/or the time and date the message was posted. In another embodiment, the user name and the secure message that was posted will not be shown at all to the users not having access to the public key (i.e., no access rights to view), which can be used to decrypt the message. For those users with whom the message was shared, the viewing of the message in the feed can be transparent, i.e. no decryption knowingly takes place to the user viewing the message. When a user having access to the public key calls on the feed (e.g., opens an object page for viewing), the message is automatically called and decrypted by the system. In one embodiment, the user with whom the encrypted message is shared can select the encrypted posting (e.g., message text) and then be prompted to enter his/her login password. Entering the login password calls the user's private key to decrypt the message. The aforementioned embodiment provides an additional level of security in the case where a user may wish that secured information is not readily made viewable by the system each time a feed is viewed.

When the message is posted, the encrypted message is also stored in a record (e.g., table) of the feed. A table is associated with the object record on which the feed is displayed in the database system. The table can include such identifiers as the entity (e.g., object), tenant id, user id, data entry in the feed (i.e., text of the message) and a field including the public key used to encrypt the data which identifies that the data is in encrypted form. In some embodiments, the table can be associated with multiple objects and can include a column identifying to which object the feed message is associated.

In step 404, an intended recipient logs into the multi-tenant database system and accesses his/her account. When the user logs into the system, utilizing a password, personal identification number (PIN), a combination of both or any additional identifying information known only to the user entering the system, the user's login information can be utilized to access their private key. For example, the user's private key can be decrypted with their log in information. In alternative embodiments, the user's private key can be stored locally on the computing device utilized to gain access to the database system.

In an embodiment, the user needs to be logged onto the system in order for them to have access to his/her private key as his/her private key can be also be encrypted when that user logs out of the system. The user's private key is then encrypted and there is no way for an administrator in the tenant of the user and/or an administrator of the database to be able to access the key to view the secure message in the feeds to which the user subscribes. Accordingly, the messages remains securely encrypted when at rest in the system. The entire encryption and decryption process can be transparent to both the user entering message into the feed and the user accessing the feed.

In step 405, if a user has access rights, i.e., the user has access to the public key used to encrypt the message, a second key associated with the user accessing the feed is utilized to decrypt the message. The second key can be the user's private key, which is unique to every user and protected by the user's password. In an alternative embodiment, user's private key can be stored locally on the user's computer which is being utilized to access the database. In such an embodiment, the private key has no dependency to the user's password and an applet is used to call the key for use on the database. Such a local storage of the key is described in commonly owned U.S. application Ser. No. 12/750,639, entitled “Enhanced System Security” by O'Connor et al. (Attorney Docket No. 021735-005810US). In whichever embodiment, the private key can be utilized to decrypt any data, such as a message, comment, story, etc., which has been marked private and securely shared with the user and encrypted with their public key. In the embodiment described in method 300, the second key is used to decrypt the message in the feed only when the user is logged into the system and accessing the feed. Accordingly, the encrypted message remains encrypted in the feed table where it is stored on the database, except when specifically called on by the user with whom it was shared.

Finally, in step 406, when an intended recipient having rights to view the message is logged into the system and requests a feed for the object associated with the message, such as a feed related to an object to which the user subscribes (which can include a profile feed of the user), the user can view the message. In some embodiments, the user can select specific types of elements provided by Chatter® for viewing. For example, a user may only wish to see the messages posted on a feed of an object, and/or the stories posted on the feed of an object, and/or stories and related comments posted on a feed of that object. When the user selects a specific feed for viewing, the user's private key is transparently used to decrypt the secured elements of Chatter® (e.g., messages) called from the database for viewing. In an embodiment, the public messages in a feed are automatically viewable by a user when that user views a feed and the user is required to re-enter his/her login information (e.g., password) in order to decrypt encrypted messages in the feed to which the user subscribes. In other embodiments, the messages in a user's personal profile feed are automatically decrypted when they user views his/her profile feed, but the user is required to re-enter his/her password in order to decrypt private messages posted on feeds to which the user subscribes, such as may be the case when a user is viewing an object feed of record of a company which is not related to a user of the system, e.g., Deal Object, Opportunity Object, etc.

### V. Sharing Rules for Secure Feed Data

With the system implementing a business networking and cross communication between users, much of the information shared between the users is to remain private due to client-privileged rights, due to the information being personal between two users, or due to the desires of a specific group administrator. In further embodiments, though the information shared (e.g., in a feed) in the business networking environment can remain publicly viewable by a plurality of users (e.g., subscribers) on the database, there may be a desire to keep the information limited to a specific group of users in that plurality of users on the database. Similarly, users may wish to selectively mark one message on a feed as private, while keeping other message public. For example, a user A may subscribe to a feed of another user B. Accordingly, user A has access rights to see user B's feed. User A may wish to post a message regarding his/her company on user B's feed. However, user A's company is a direct rival of user C's company and user C is also a subscriber on user B's feed. Accordingly, user A prefers to post his/her message securely, so that user C is not able to view it. User A can easily impose such security on any message posted to a feed to which he/she is subscribed. The data, or message to be posted in a feed, is marked as private by the user A. By marking the message as private, the message is encrypted when it is both shared in the feed and stored in the database.

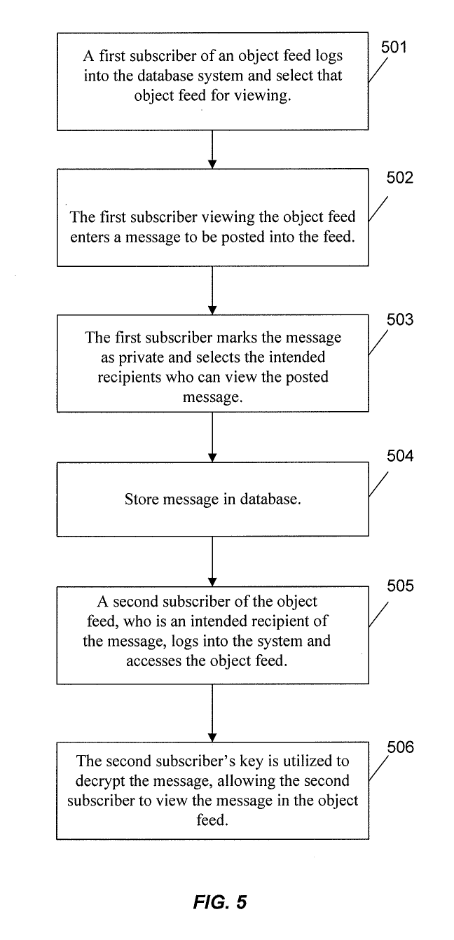

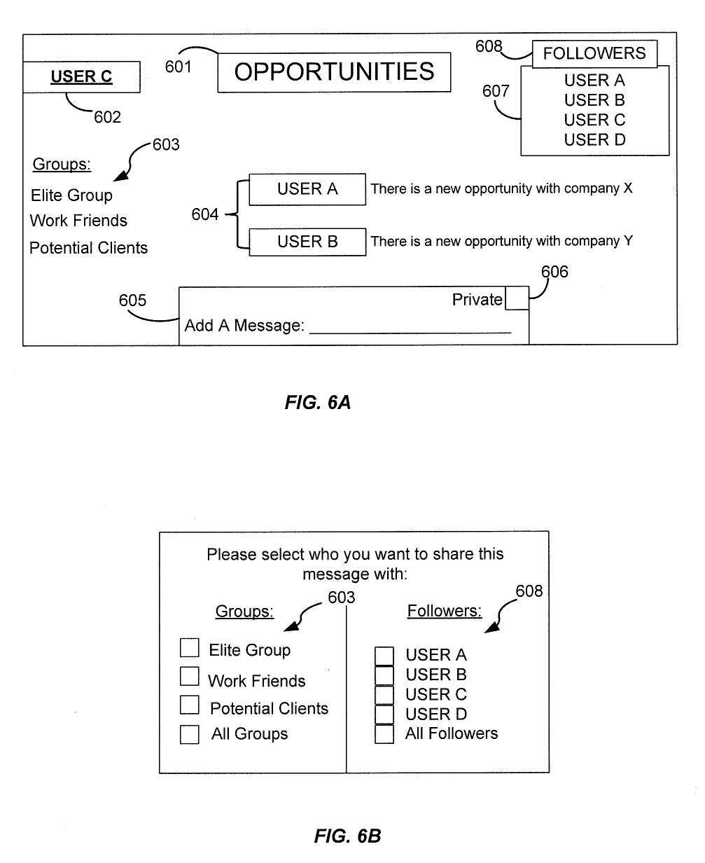

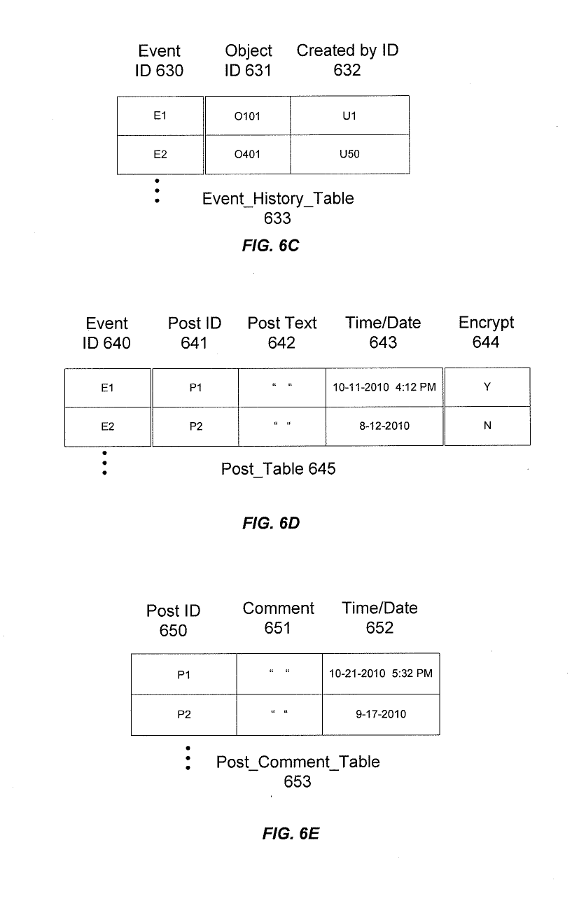

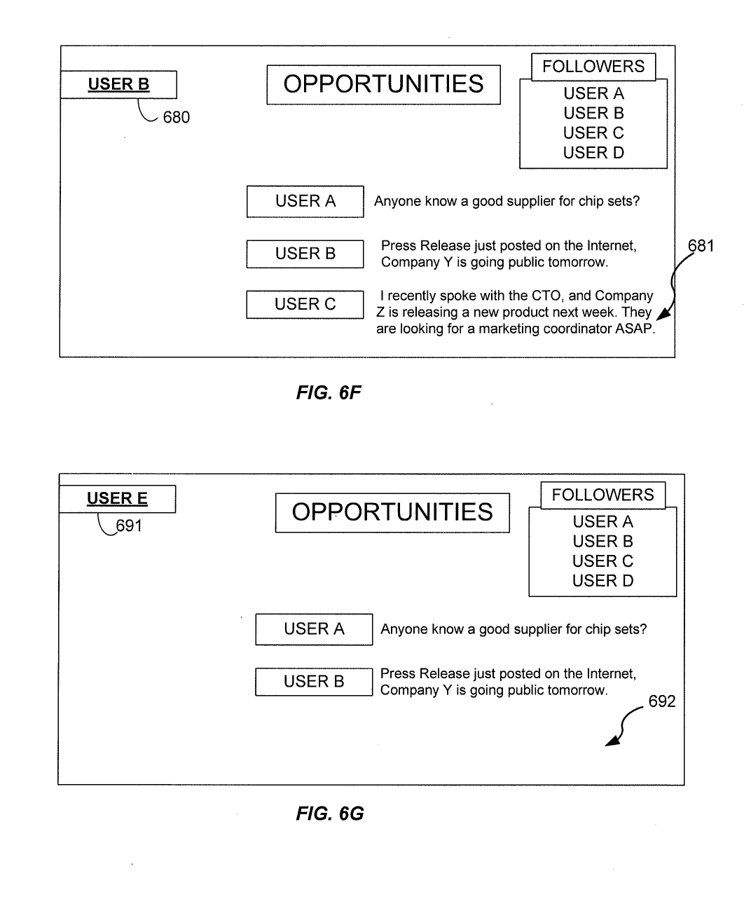

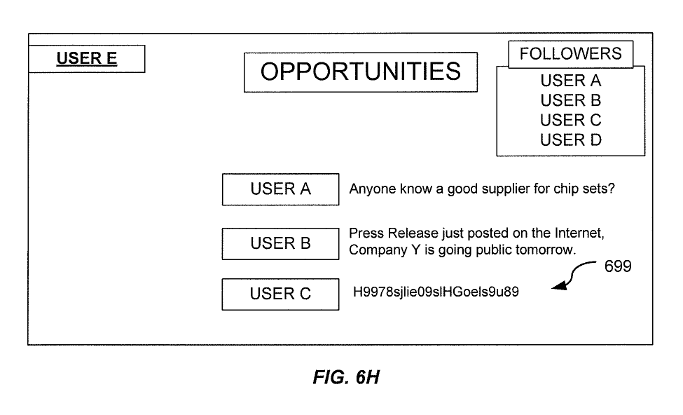

FIG. 5 is a flowchart of an exemplary embodiment of a method 500 illustrating how a user in a group of users can selectively share a message in a feed and view that message in the feed. The steps of method 500 are described with reference to FIGS. 6A-6 H, which provide exemplary screenshots of what a user views in an exemplary object feed on a multi-tenant database in an embodiment.

In step 501, a user logs into the multi-tenant database system. As previously described, when the user logs into the system, the user's password is utilized by the system to decrypt the user's private key, which is a unique key to that particular user. Each user is assigned a private key linked to their account and login information (e.g., password), such that the user's private key is protected when the user is not using the system.

After entering the system, the user can select any one of the objects (including feeds of the objects) to which he/she has viewing access rights. In some embodiments, these object feeds can be only of the objects to which the user subscribes. However, in other embodiments, the object feeds can be for any public object that is viewable by users of the database.

As shown in an embodiment of FIG. 6A, the object feed Opportunities 601 includes a list 607 of followers 608 (i.e., subscribers) that subscribe to that object feed. Though the object feed for the entity Opportunities is provided, the feed could be for any object feed on the database, such as user's profile feed or any other object having related records for which a feed can be generated. FIG. 6A is a screenshot illustrated from the perspective of user C 602, who is a subscriber to the object feed Opportunities 601, as shown in list 607. Accordingly, when user C views the feed, messages 604 posted by user A and user B are visible. As previously noted, these feed elements (e.g., messages 604) may be visible to user C because user C is a subscriber and/or the object feed Opportunities 601 has public access rights for viewing. In FIG. 6A, a list of groups 603 is defined, which can be pre-selected by user C. These groups may include groups to which targeted emails are often sent by user C, specific groups of co-workers known to user C, or any other group of users which user C has formed for personal reasons. Additionally, a number of these groups may be formed by default from the administrator of the tenant and/or owner of the object feed to include specific groups which are to be notified for various reasons pertaining to information shared through the object feed.

Referring again to FIG. 5, in step 502, a message box 605 is made available in the object feed for Opportunities 601, which provides a field into which user C can freely enter text for posting (sharing) a message in feed. The message box can be located anywhere on the object page and/or it can appear from a prompt after clicking on a “message” button on the object page. The message box can be limited to a number of words, dependent on the number of users in the feed, the size of the record available in the database for the feed, and/or can be unlimited. Additionally, restrictions regarding the text entered can also be imposed by the administrator of the tenant overseeing the objects in the database. Included in the message box can be an additional box, such as a radio button or toggle switch. The additional box can be selected to mark the message ‘private’ and identify to the system that the message is to be encrypted prior to posting and storage on the system. In some embodiments, if the user of has pre-selected that all messages are to be marked private, the additional box may not appear to the user when entering a message. Similarly, if the owner of an object and/or an administrator has indicated that all messages and/or other feed elements are to be secured, the additional box may not appear.

Referring back to FIG. 5, in step 503, after user C enters a message into message box 605, user C marks the message as private in box 606. After selecting the message to be private, the system can provide an additional pop-up window, show in FIG. 6B, to user C for selection of which users the message is to be made viewable, i.e., the intended recipients of the message. As shown in FIG. 6B, a list of the user's pre-selected groups 603 is provided, along with a listing of each of the individual followers 608, or subscribers, to the object feed Opportunities. Additionally, a selection of ‘All Followers’ made be provided in the case that the object feed Opportunities 601 has public access rights for viewing and user C only desires that the followers of the feed to be able to view the message posted in the feed. User C can then select which groups and/or users are going to have rights to view the message. In one embodiment, if the object is a group of users, a default of the users in the group can be selected as intended recipients.

In an alternative embodiment, the user can pre-select the sharing rules for messages they enter into an individual object feed, such as defining specific groups, users, etc. for each object feed, with whom any message posted in the feed will be shared. In yet another embodiment, the user can pre-select sharing rules for any message in which he/she enters into the system, such as the user select pre-defined feed preferences for his/her account. If any of the aforementioned embodiments are implemented, the system can transparently apply these sharing rules to the user's messages entered into an object feed and, consequently, the pop-up window provided in FIG. 6B will not appear to those users and/or the pre-selected users with whom the user wishes the share messages may not be included in the listings of groups and/or users.

In step 504, the message is stored in the multi-tenant database system. As previously mentioned, the message is stored in a record associated with a feed of an object or objects, dependent on the embodiment. The storage of the message in a table is described further with reference to FIGS. 6C-6E in the following paragraphs.

Referring now to FIG. 6C, once user C has selected with which users to share a message, the message is assigned an Event ID 630 and stored in a table identifying to which object, e.g., Object ID 631, the event occurred, and an identifier for which user caused the event, i.e., entered the message, noted by the column labeled Created by ID 632. The Event_History_Table 633 provides a listing of all events occurring in the feed. Events can include stories, comments, messages, addition of subscribers, related field updates, etc. Events and the mapping and storage of the events on the database systems is further described in commonly application U.S. patent application Ser. No. 12/945,410, filed Nov. 12, 2010, entitled “Enterprise Level Business Infoiivation Networking for Changes in a Database.”

Referring now to FIG. 6D, the actual message text and related data is stored in a separate Post_Table 645. The Post_Table 645 shown in FIG. 6D, provides various fields which are used to document the message, such as Post ID 641 to number the post entry, Post Text 642 to provide the contents of the message entered, Time/Date 643 of when the message was entered, and an additional Encrypt 644 field which identifies if the message was marked ‘private’ by the user and/or system in pre-selected preferences. If the Encrypt 644 field identifies the message as ‘private,’ the Post Text 642 field includes encrypted text. Additionally, the Encrypt 644 field can include the type of encryption utilized for the message, i.e., symmetric, PKI, etc.

A post in a feed can have comments associated with the post, which are appended to the message. As discussed in previous sections, the privacy of the message in the feed may determine the privacy of the comment posted on the message. For example, if user C in FIG. 6A marks a message private for user A, a subscriber of object feed Opportunities to view, then a comment posted by user A in response to the message may only be viewable by user C and user A. Alternatively, if comments and message (e.g., posts) have different sharing rules, the message posted by user C may only be viewable to user A, whereas the comment posted by user A in response to the message may be viewable by anyone having access rights to view the object feed Opportunities. In an embodiment, the comment text field box (not shown) that allows a user to enter the text of his/her comment onto the message, may additionally include a field for marking the comment as private, similar to that which is shown in FIG. 6A.

In one embodiment, comments made on a post are stored in a separate table as shown in FIG. 6E. The Post_Comment_Table can include any number of fields, such as Post ID to indicate on which post (e.g., message) the comment was made, Comment Text 651, and the Time/Date which the comment was added to the message. In some embodiments, an additional field can be included to identify if the comment is to be encrypted and has been marked private as well as to indicate the type of encryption utilized by the system to encrypt the comment.

Referring back to FIG. 5, in step 505, another user within the multi-tenant database system enters the system and selects an object feed for viewing. Each user viewing an object feed can potentially have a different view of a feed. For instance, one user may only be able to see stories in a feed if they are not a subscriber, i.e., all messages are automatically ‘private’ and not shown in a public feed unless a user is subscribed to that feed. In another example, a user may only see feed elements, e.g., posts, comments, stories, etc., that are from selective subscribers of that feed, if feed elements provided by some subscribers are always privately shared with only a selected group of users subscribing to that feed. In other embodiments, the user subscribing to the feed may wish to view only feed elements from select subscribers to the feed and/or select items within the feed (e.g., stories). In the aforementioned embodiments where the user only wishes to view feed elements from select subscribers, the system can make the unwanted feed elements transparent to the user. In another embodiment, particular messages may be selectively encrypted (marked as private) with intended recipients chosen on an item by item basis.

In step 506, if the user has access rights to view a feed element, the system can transparently decrypt the message with the user's private key when the user selects the object feed for viewing. This decryption can be transparent to the user. In alternative embodiments, the user may view the object feed and select an encrypted message, and then be prompted to re-enter his/her password in order to gain viewing rights. As mentioned in the previous paragraph, every user can potentially view a different feed for the same object feed, dependent on access rights and imposed sharing rules. Accordingly, certain feed elements can be decrypted when the user selects the object feed, while others require an additional level of security (e.g., decryption), such as the aforementioned re-entry of the user's password. The appearance of the encrypted and decrypted feed elements dependent on the user's access rights is further described in the following paragraphs with reference to FIG. 6F-6H.

As shown in the exemplary embodiment of FIG. 6F, user B 680 is viewing the object feed Opportunities 601. User B 680 also subscribes to the feed. Referring back to FIG. 5, in step 506, when a user having access rights selects the object feed Opportunities 601, the user can view a decrypted message added to the feed. The access right may be whether that particular message is marked to have the user as an intended recipient, or if a more general rule (e.g. a default of messages from a user or containing certain words) In the embodiment illustrated in FIG. 6F, user C has given access rights to user B for viewing the message 681 previously entered.

In one embodiment, though user B can view the private message 681 from user C, the system does not allow the private (encrypted) message 681 to be “re-posted” or otherwise forwarded to another user within or outside the system. Similarly, in the embodiment of a user's personal profile feed, the user may also be prevented from forwarding any message received from another user and posted to his/her feed if the message is marked private. In another embodiment, a recipient (e.g., user B), can also be prevented from copying-pasting a message or obtaining a screen capture. In an alternative embodiment, a recipient can be allowed to perform a simple copy-paste or screen capture. The forwarding and copying of messages and other feed elements can alternatively be controlled by a system administrator, tenant administrator and/or owner of a particular object feed. Such sharing rules can be pre-defined and/or pre-selected in the system.

Referring now to FIG. 6G, an alternative viewing of the object feed Opportunities is shown. In FIG. 6G, user E 691, who may or may not be a follower of the object feed Opportunities, is viewing the feed. In this embodiment, user E has access rights to the object Opportunities, which can be due to the object being viewable to all users on the database or just a group including user E. However, because user C has marked his/her message ‘private,’ (with user E 691 not being on a list of intended recipients) user E 691 does not have access rights to view the message in the feed. As shown in FIG. 6G, user C's message 692 is absent (e.g., blank) from the feed as well as user C's name. In another embodiment, user C's name could appear in the feed with a blank message space.

FIG. 6H provide an alternative embodiment of the aforementioned scenario, having user E view a feed and a subscriber to that feed, user C, marking a message ‘private’ in that feed. In FIG. 6H, the message 699 from user C is visible to other users not having access rights to view it, such as user E. However, when the message appears in the feed, the ciphertext of the secure (e.g., encrypted) message 699 is shown. This ciphertext format can be any known in the art. In one embodiment, the user's name, e.g., “user C” can also appear in ciphertext to protect that user's privacy.

As discussed with reference to FIGS. 5-6, in one embodiment, when a user flags a message (or other feed element) as ‘private,’ the message is encrypted with the public key(s) of the intended recipient or group of recipients, dependent on which recipients the user selects. In another embodiment, the system can generate a feed element and automatically encrypt the feed element based on one or more settings (including default settings) which the user and/or an administrator of the tenant and/or owner of an object feed has pre-selected. In the aforementioned embodiment, the pre-selection of the feed element can be separate from other feed elements, i.e., messages are always ‘private,’ whereas comments are always left public. Alternatively, a user can pre-select sharing rules (e.g., privacy settings) for object feeds in general, such as all information shared by the user in the feed is ‘private.’

In various embodiments, the user can specify the intended recipients independently, with a group identifier, such as shown in FIG. 6B, or let the system determine the intended recipients. For example, if a comment is made on a story for a particular record, then the intended recipients can be anyone who is allowed to see that record. The stories themselves can also be encrypted, as well as the underlying data. In one embodiment, this secure maintenance of data is performed as described in U.S. application. Ser. No. 12/750,639, entitled “Enhanced System Security” by O'Connor et al. (Attorney Docket No. 021735-005810US).

Furthermore, due to the hierarchical architecture of the database, in one embodiment, if the user has access to the parent entity (e.g., subscribes to an object feed) the user is able create feed data (e.g., comments, messages, etc.) and delete his/her respective message in the feed. If the user deletes an element within the feed, the previously stored record and related records of the feed element (e.g., message) can be dynamically erased in the system and/or require an administrator of the tenant allow the record and/or any related record of the feed element to be permanently erased. In another embodiment, if the user has access rights to the parent entity, the user does not have delete privileges.

### VI. Encryption

To secure feed elements when a user defines sharing rules for one of those elements, such as a message, any encryption technique known in the art can be used. As described in previous sections, in one embodiment, each user is assigned a key pair, including at least one private key and one public key. The private key can be protected with the user's password utilized to enter the system 16 and encrypted each time that the user logs out of the system and decrypted each time that the user logs into the system. Additionally, when the user changes their password, the protection on the key can also be changed and updated in the system to keep the private key in sync.

In an embodiment, such as in the case of asymmetric key algorithm encryption, a solution is to combine the messages with a public and private key encryption system, e.g. using the Rivest Shamir, Aldeman technique (RSA) and/or public key infrastructure (PKI). As is known in cryptography, the asymmetric key algorithm generates a corresponding public key (e.g., a random number) and private key pair for each user on the system. When a first user marks a message as ‘private’ for a second user, the second user's published public key is utilized to encrypt the message. The second user's private key can then be utilized to decrypt the received message. In such an embodiment, no key exchange between the two users is required prior to posting a secure message in an object feed and only the second user's key pair is utilized for encryption. This method can be useful for sharing rules imparted between two select users, such as on a user's profile feed.

In an alternative encryption technique, a symmetric key algorithm encryption can be utilized. In a symmetric key technique, keys from each user are used to generate a commonly shared key between users. The symmetric key an be assigned to a user as either that user's public keys, such as one assigned to the user in a public/private key pair, or a secondary public key, such as one assigned to a group in which the user is a subscriber and/or between the user and at least one other user when sharing a message. In the example of a group, the group can include other users which are mutually subscribing to the user and/or other objects or records within certain objects. As each user joins the group, a new public key is generated from keys of the each of the users in the group and the public key is shared with each member of the group prior to use of the key for encrypting a message, such as the case in Diffie-Hellman technique. Because the public key is generated from the unique private keys and public keys of each user in the group, any unique private key belonging to a user in the group can be used to decrypt the message which is encrypted with the public key.

Though the aforementioned method of symmetric encryption allows for limits on the size of public keys shared between users, generating a new key each time that a new user joins a group, or makes a group (e.g., between two selected users) requires additional processing by the system and requires that the key is shared between the users prior to posting a secure message in a feed. Additionally, for sharing message and providing numerous selections of users with whom specific information is shared requires the system to store a number of shared symmetric (e.g., public keys) which are generated dependent on each selection of users, which requires additional storage space. Accordingly, using this type of encryption only on selective feed messages can provide improved system functionality.

As previously mentioned the requirements for both symmetric and asymmetric key encryption can require additional processing and memory in the database systems in select circumstances which can, consequently, limit the feed elements for which each type of encryption is utilized to maintain an efficient system. For example, the use of asymmetric keys can require added memory to store numerous public keys used to encrypt a single message posted to a feed. As well, the use of a symmetric public key may require additional time to share the key prior to posting a messages, which is can be expedited through use of an asymmetric private/public key encryption system. Accordingly, a combination of the two cryptographic techniques can be utilized to minimize both cost and encryption/decryption time. For example, a symmetric key can be utilized for encrypting the feed elements in large groups, such as a group of subscribers (i.e., followers) in an object feed, or such as when the data is stored in the tables on the multi-tenant database system.

The specific details of particular embodiments may be combined in any suitable manner without departing from the spirit and scope of embodiments of the invention. However, other embodiments of the invention may be directed to specific embodiments relating to each individual aspect, or specific combinations of these individual aspects.

It should be understood that the present invention as described above can be implemented in the form of control logic using hardware and/or using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C++ or Perl using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer program product (e.g. a hard drive, a CD, or an entire computer system), and may be present on or within different computer program products within a system or network. A computer system may include a monitor, printer, or other suitable display for providing any of the results mentioned herein to a user.

The above description of exemplary embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

What is claimed is:

1. A method of securely sharing a message in a feed of an object on a database system, the method comprising:
receiving a message from a user of the database system,
associating the message with the feed of the object, wherein a plurality of users have access to the feed and the message is selectively shared with one or more intended recipients of the plurality of users;
encrypting the message with a first key;
storing the encrypted message in a table of the database system, the table being used in providing the feed; and
retrieving the encrypted message from the table and decrypting the encrypted message with a second key when one or more of the intended recipients requests the feed, wherein each of the one or more intended recipients has access to the second key.

2. The method of claim 1, further comprising: displaying, to the one or more of the intended recipients, the decrypted message in the feed.

3. The method of claim 1, wherein the object is a user profile or a record of the database.

4. The method of claim 1, wherein the second key is the first key.

5. The method of claim 1, wherein the one or more intended recipients are selected by the user.

6. The method of claim 1, wherein the intended recipients are selected by the database system according to a rule.

7. The method of claim 1, wherein the feed includes any one or more of the following: updates to a record in a database, a comment on an update of a record, a post, or a message.

8. The method of claim 1, wherein the encrypted message is decrypted in response to the user accessing the feed.

9. The method of claim 1, wherein the second key is encrypted when the user is logged out of the database system.

10. The method of claim 1, wherein second key is encrypted using a password of an intended recipient to form an encrypted decryption key.

11. The method of claim 10, wherein the tables includes at least one field for storing the encrypted decryption key.

12. The method of claim 1, further comprising:
receiving a password of an intended recipient to log into the database system; and
decrypting the second key using the password.

13. The method of claim 12, further comprising:
preventing the intended recipient from forwarding the decrypted data.

14. A computer program product comprising a tangible computer readable medium storing a plurality of instructions for controlling a processor to perform an operation for securing an element of a feed in a database system, the instructions comprising the method of claim 1.

15. A database system comprising:
one or more processors configured to perform the method of claim 1.

16. A method for securing data in a feed associated with an object on a database system, the method comprising:
assigning a first key and a second key to a user;
encrypting the first key with a password set by the user, wherein the first key is decrypted with the password when the user logs into the database system; and
utilizing the decrypted first key to decrypt data in the feed,
wherein the data is shared by at least one of a plurality of users having access to the feed, and
wherein the data shared by the at least one of a plurality of users is encrypted with the second key.

17. The method of claim 16, wherein the user is required to re-enter the password to decrypt the encrypted data.

18. The method of claim 16, wherein the first key is a private key and the second key is a public key.

19. A method for securely sharing data between a group of users in a feed associated with an object on a database system, the method comprising:
receiving data from a user in the group of users;
encrypting the data with a first key of the user;
utilizing a second key to encrypt the first key, wherein the second key is formed from a set of unique keys, each user in the group of users being associated with a unique key in the set;
displaying the encrypted data in the feed, wherein the feed is accessible to a plurality of users on the database system; and
storing the encrypted data on the database system.

20. The method of claim 19, further comprising:
in response to a user in the group of users accessing the feed, decrypting the encrypted first key with the unique key associated with the user;
utilizing the first key to decrypt the encrypted data; and
displaying the decrypted data to the user in the group of users that is accessing the feed.

21. The method of claim 20, wherein having access to the feed does not provide capabilities to view all data in the feed.

22. The method of claim 20, further comprising:
in response to adding a new user to the group of users, decrypting the first key;
adding a new unique key from the new user in the group of users to the set of second keys;
re-encrypting the first key with the set of second keys; and
forming a new first key.

23. The method of claim 22, further comprising:
re-encrypting any data shared between the users in the group of users with the new first key.

24. The method of claim 23, wherein the data includes one or more elements in the feed.

25. The method of claim 19, wherein each of the unique keys a private key.

26. The method of claim 19, wherein the first key is a symmetric key.

27. The method of claim 19, wherein the group of users is associated with a record on the database system.
